(19) United States
(12) Patent Application Publication
(10) Pub. No.: US 2008/0276277 A1
(43) Pub. Date: Nov. 6, 2008

(54) Method and system for presenting television program guide information based on viewer usage patterns

(75) Inventors: Sun Hong Ahn, Ladera Ranch, CA (US); Jason Rowe, Aliso Viejo, CA (US); Taehee Kim, Ridgefield, NJ (US); Paul Suntae Kim, Mahway, NJ (US); Byung Chan Kang, Downey, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/800,181

(22) Filed: May 3, 2007

(51) Int. Cl. H04N 5/445

(52) U.S. Cl. 725/40

(57) ABSTRACT

A method and system for presenting television program guide information is provided. A program guide is obtained, and program viewing patterns of a viewer are monitored. Information from the program guide is selectively presented to the viewer based on the viewing patterns. Selectively presenting information from the program guide includes displaying a listing of channels viewed more frequently on a guide screen in descending order of viewing frequency.

### FIELD OF THE INVENTION

The present invention relates to television program guide presentation, and in particular, to presenting television (TV) program guide information based on viewer usage patterns.

### BACKGROUND OF THE INVENTION

A typical television program guide screen includes multiple pages, and many (often more than fifty) pages of information.

Devices that present program guide information typically display the information in a pre-determined order; either in numerical order of channel numbers, or in alphabetical order of channel names. In either case, information for channels of interest to a viewer often appear on pages and in sequence in the program guide that have no correlation to the viewer's interest. This forces the viewer to frequently navigate to the pages of interest either by scrolling through screens or by typing in channel numbers. Neither of these navigation methods is convenient, and both methods are time consuming.

Though in some applications a viewer is allowed to edit the order of channel display, such listings require manual editing whenever the viewer desires to change the display order. There is, therefore, a need for a method and a system for presenting television program guide information based on viewer usage patterns.

### BRIEF SUMMARY OF THE INVENTION

The present invention provides a method and system for presenting television program guide information. In one embodiment this involves obtaining a program guide, monitoring program viewing patterns of a viewer, and selectively presenting information from the program guide to the viewer based on the viewing patterns. In one example, selectively presenting information from the program guide further includes displaying a listing of channels viewed more frequently on a guide screen in descending order of viewing frequency.

In another embodiment, monitoring program viewing patterns further includes monitoring viewing pattern changes, such that selectively presenting information from the program guide includes selectively presenting information from the program guide to the viewer based on the viewing pattern changes.

In another embodiment, channels of more interest to the viewer appear first on the guide screen relative to other channels, wherein selectively presenting information from the program guide further includes showing program guide information for viewer preferred channels regardless of watching time.

These and other features, aspects and advantages of the present invention will become understood with reference to the following description, appended claims and accompanying figures.

### BRIEF DESCRIPTION OF THE DRAWINGS

FIG. 1 shows a functional block diagram of an example system for presenting television program guide information based on the viewer's usage pattern, according to an embodiment of the present invention.

FIG. 2 shows a flowchart of a process for presenting television program guide information based on the viewer's usage pattern implemented in the system of FIG. 1, according to an embodiment of the present invention.

FIG. 3 shows an example list of favorite channels the user tuned into, indicating viewing patterns of the user, according to an embodiment of the present invention.

FIGS. 4-5 demonstrate the difference between a conventional program guide display in FIG. 4 and an example program guide display in FIG. 5 according to an embodiment of the present invention.

### DETAILED DESCRIPTION OF THE INVENTION

With the proliferation of television programming, typically, there are several hundred channels available for viewing. Most viewers have a few frequently watched favorite channels. The list of preferred channels can be different for each viewer and further may change per viewer over time. For example, a viewer may watch more sports channels during the weekend than weekdays.

The present invention provides a method and a system for presenting television program guide information based on viewer usage patterns. A presentation system monitors viewing patterns of television programs and selectively displays program guide information on a guide screen for channels based on the viewing patterns. The channels watched more often are user preferred channels, and therefore presented to the viewer first, relative to other channels. If the viewing pattern changes, such changes are used to selectively display program guide information for channels based on the viewing pattern changes.

The viewing patterns are used for presenting channel listings to a viewer without requiring manual selection by the viewer. As such, the viewer can watch preferred channel information simply and quickly, without needing to engage in manual entry of channel preferences on the guide screen.

In one embodiment, frequently watched favorite channels for each viewer appear at the beginning of the program guide display. The usage pattern for each viewer is used in presenting the program guide information for that viewer, such that channels of more interest to the user appear first without requiring manual configuration change. In this description, the term “configuration” means a set of parameters that can be modified by users based on their preferences. For example, a television may allow users to utilize a menu screen for editing channel display order on a guide screen.

In one example, the TV usage patterns of a viewer or a group of viewers are monitored. The usage/viewing patterns are used for customizing program guide information display per viewer. The channels watched more often move to the front pages of the guide screen. If the viewing pattern changes either because of a viewer change or a viewing time slot change, the new usage pattern is used for dynamically customizing the display of the guide screen. As such, the viewers can quickly and easily access information for their preferred channels, without manual editing for channel information display preference on the guide screen.

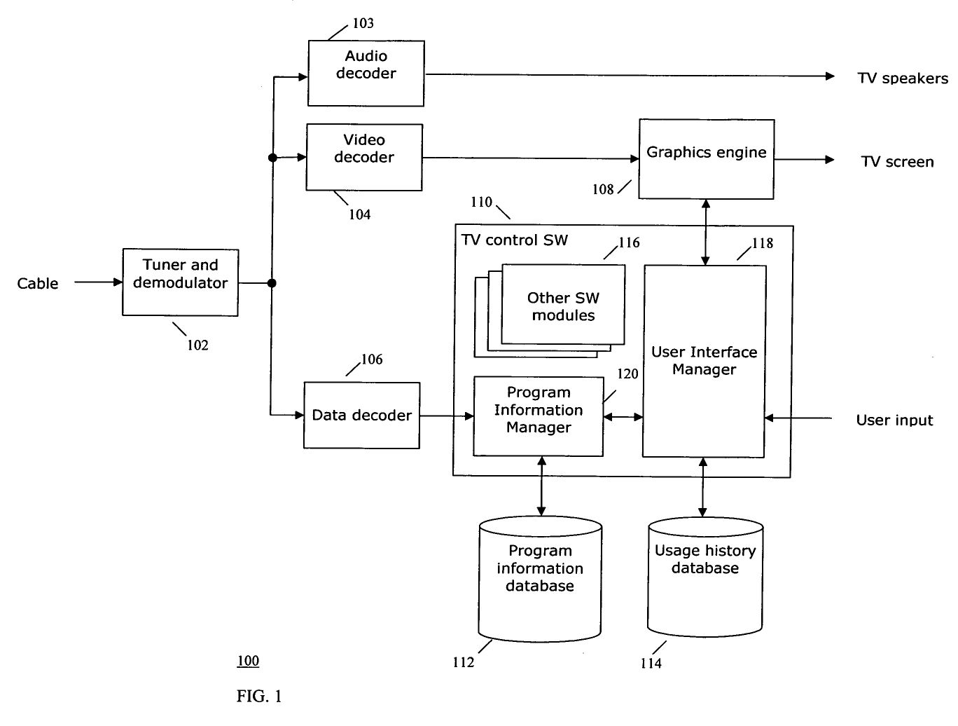

FIG. 1 shows an example functional block diagram of a system 100 for presenting television program guide information based on the viewer's usage pattern, according to an embodiment of the present invention. The system 100 includes a tuner/demodulator 102, an audio decoder 103, a video decoder 104, a data decoder 106, a graphics engine 108, a TV control software (SW) module 110, a program information database 112 and a usage history database 114. The TV control module 110 includes software modules 116, a user interface manager (UIM) 118 and a program information manager (PIM) 120. The software modules 116 are not related to the processing of the program information, but provide such functions as conditional access, emergency alert, closed-caption, etc.

In FIG. 1, the incoming signal (e.g., a radio frequency (RF) signal from a programming source such as cable, satellite, etc.) is input to the tuner/demodulator 102 which tunes to a channel and demodulates signals to retrieve digital data including audio, video and data.

The audio content is decoded by the audio decoder 103 to generate audio sound played through speakers (e.g., TV speakers).

The video content is decoded by the video decoder 104 to generate a video signal that is processed by the graphics engine 108. The processed video information is then displayed on an electronic display screen (e.g., a TV screen).

The data content is decoded by the data decoder 106 and processed by the TV control module 110. Program information is processed by the PIM 120 and stored in the program information database 112.

When a viewer inputs a request (e.g., using TV buttons, a remote control, etc.), the request is received by the UIM 118 to determine the type of user request. Based on the user request, the UIM 118 operates to generate a visual feedback that is delivered to the graphics engine 108 for combination with a video signal from the video decoder 104, before display on the display screen.

If the user request involves a channel change, then the UIM 118 records the viewer's usage data (e.g., channel number, tuning time, etc.) to the usage history database 114.

If the user request is to display program guide information, then the UIM 118 sends a request to the PIM 120 to obtain program guide information. The PIM 120 retrieves program information from the program information database 112, and delivers the program information to the UIM 118. Then, the UIM 118 generates visuals that are delivered to the graphics engine 108 for display on the TV screen.

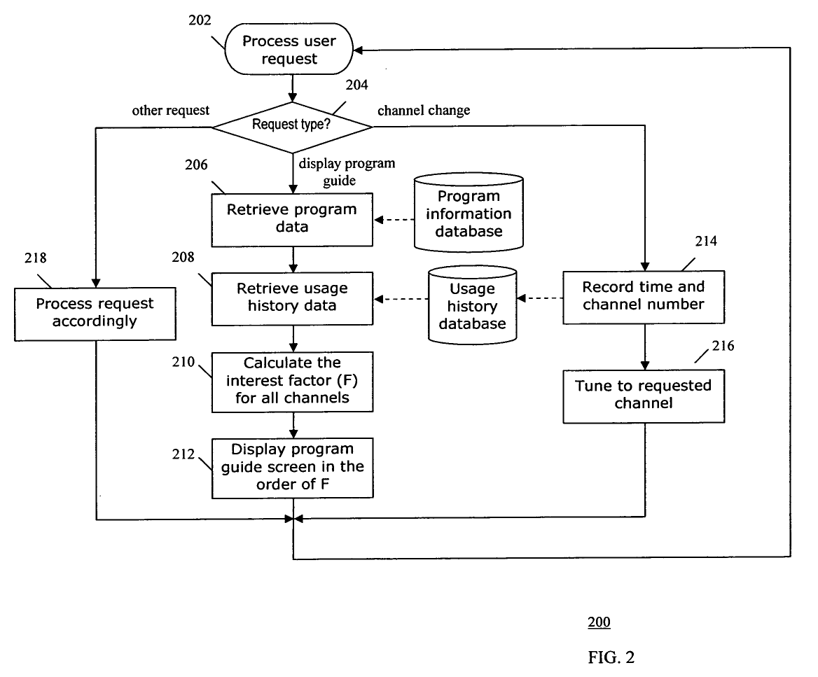

FIG. 2 shows a flowchart of an example process 200 for presenting television program guide information based on the viewer's usage pattern, according to an embodiment of the present invention. The process 200 includes the steps of:
Step 202: The user interface manager 118 awaits a viewer request.
Step 204: Upon receiving a user/viewer request, the UIM 118 determines the request type. If the request is to “display program guide”, the process proceeds to step 206. If the request is “channel change”, the process proceeds to step 214. Otherwise, the process proceeds to step 218.
Step 206: For a “display program guide” request, the PIM 120 retrieves program data from the program information database 112.
Step 208: The UIM 118 retrieves usage history data from the usage history database 114.
Step 210: Based on the retrieved program data and usage history, the UIM 118 determines the interest factor, F, for all channels. Examples of determining the interest factor, F, are provided further below.
Step 212: The UIM 118 causes the graphics engine 108 to display a program guide that lists channels in the order of the interest factor F. Then, the process proceeds back to step 202 for processing a next request.
Step 214: Upon receiving a “change channel” request, the UIM 118 records the time and the channel number in the usage history database 114.
Step 216: The tuner/demodulator 102 tunes the TV to the requested channel. The process proceeds back to step 202 for processing a next request.
Step 218: Upon receiving other types of requests (not related to displaying the program guide information) process the request accordingly, then proceed back to step 202 to process a next request. For example, if the request is to increase audio volume, the UIM 118 sends a request to one of the other SW modules 116 that is in charge of controlling audio volume.

The system 100 and the process 200 can be implemented as logical modules (hardware, software, application specific integrated circuit, etc.) in existing devices (e.g., set-top-box (STB), TV, etc.) or as stand-alone devices.

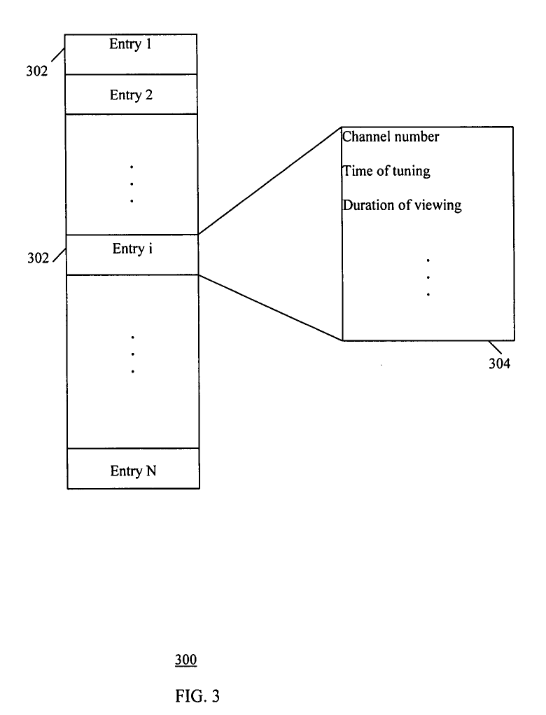

In one example implementation, the system 100 maintains a list 300 (FIG. 3) of the last N channels that a viewer tuned to. The list includes N entries 302, wherein each entry 302 for a tuned channel contains channel information 304 including channel number, time of tuning the channel, duration of viewing (i.e., the length of timing that the viewer remains tuned to the channel), etc. The list 300 is stored in the usage history database 114 (FIG. 1), and is updated as the viewer tunes to different channels. The same channel may appear in multiple entries 302 of the list 300 if the viewer tuned to the channel multiple times during the last N channel changes.

Preferably, but not necessarily, if a viewer tunes to a channel and does not remain tuned to that channel for a certain period of time (e.g., 5 seconds), that channel is not included in the list 300. This is to exclude the channels that the viewer is not really intended to tune to. The value of N can be either pre-selected by the system designer or to be selectable by the viewer. Smaller values for N are suited for those users whose viewing pattern changes in shorter-term (more quickly), while larger values for N are suited for those users whose viewing pattern is consistent over longer periods of time.

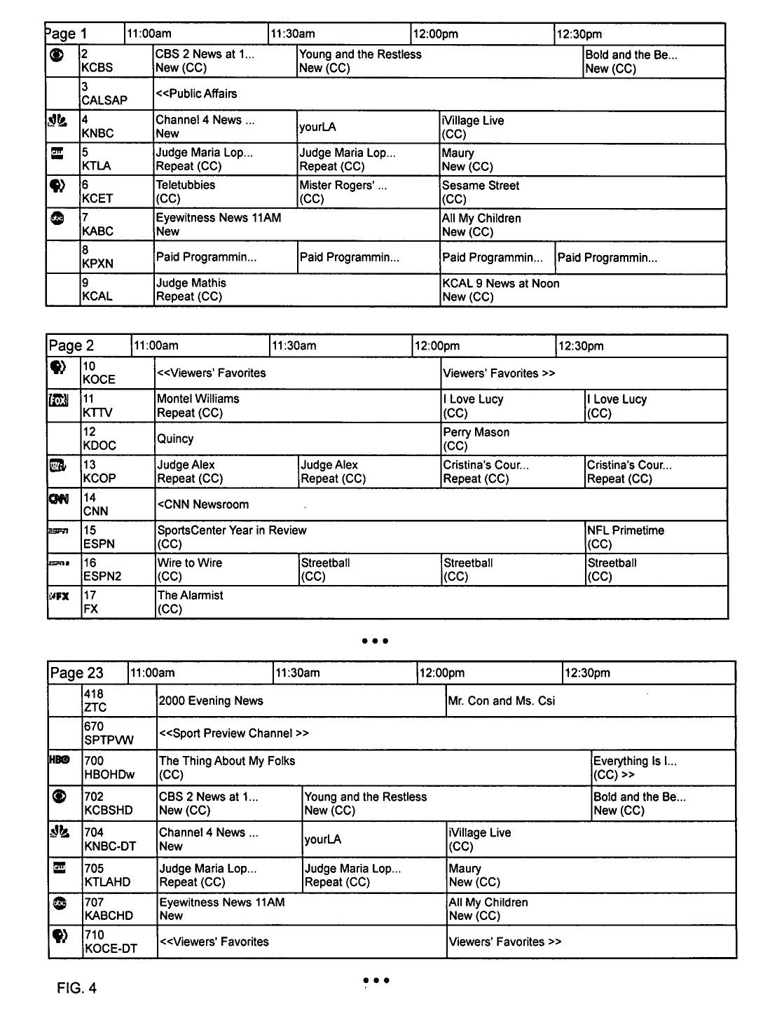

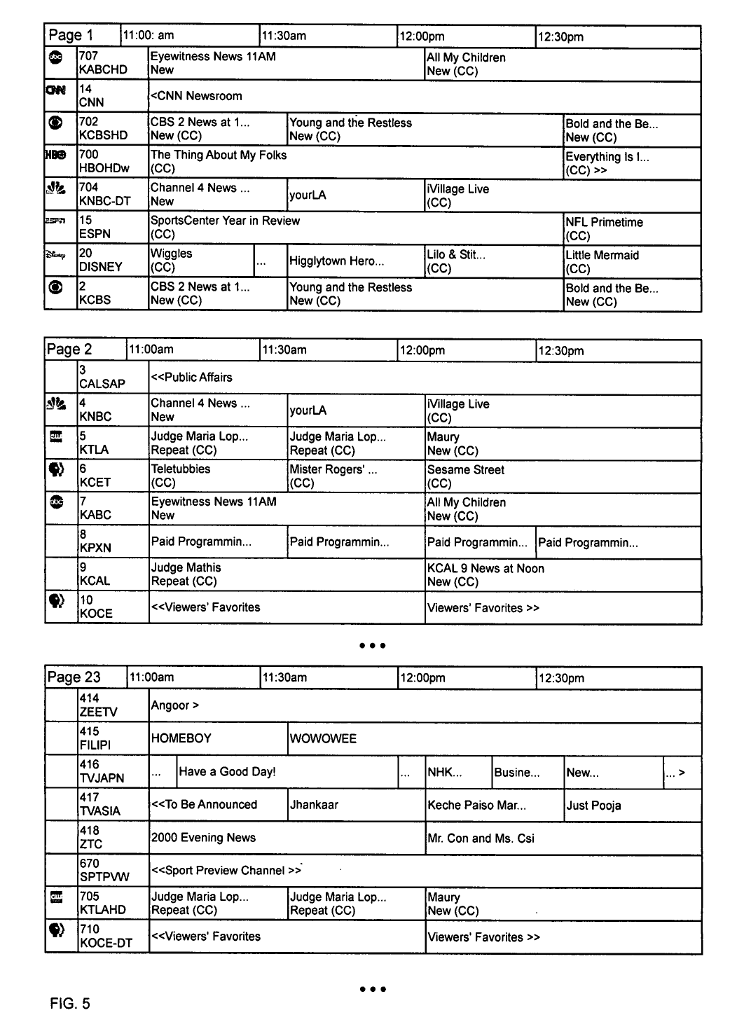

The interest factor F(x) is calculated for each channel number x in the list 300. Whenever the viewer displays the guide screen, the program guide information for each channel on the list 300 is displayed to the viewer in the order of the interest factor F(x). Channels with higher interest factors are displayed first. The channels that do not appear in the list 300 may be displayed after those channels in the list 300. FIG. 4 shows an example of an initial/conventional program guide screen (Pages 1, 2, . . . , 23, etc.) where no viewer usage history is recorded in the list 300. When a viewer watches TV and tunes to some channels more often than others, those channels are recorded in the list 300. FIG. 5 shows an example screen according to the present invention, wherein the program guide information is displayed based on viewer viewing patterns. In this example, the viewer watched channel 707 the most, and the viewer watched channels 14, 702, 700, 704, 15, 20 and 2 more often than the rest of the channels. As a result, channels 707, 14, 702, 700, 704, 15, 20 and 2 appear in the first page (Page 1) of the program guide display, and the rest of the channels are displayed thereafter.

The interest factor F may be calculated by different algorithms. Some examples of the algorithms are described below, but other algorithms may also be used, as recognized by those skilled in the art. Example algorithms for calculating the interest factor F(x) for a channel x in the list 300 include:
Most Consistently Watched (MCW): The interest factor F(x) of a channel x is the accumulated tuned time for the channel x. For example, if the channel x appears in the list 300 as tuned into 3 times (in 3 different entries 302), and the tuning durations are for 10, 45, 25 minutes, then F(x)=10+45+25=80.
Most Frequently Watched (MFW): The interest factor F(x) of a channel x is the number of appearance of the channel x in the list 300. For example, if the channel x appears in the list 300 5 times, then F(x)=5.
Most Recently Watched (MRW): The interest factor F(x) of a channel x is greater if it appears later in the list 300, meaning that it was watched more recently. For example, if the channel x appears as the first entry (i.e., the oldest entry) in the list 300, then F(x)=1. If the channel x appears as e.g. the 10^{th} list entry, then F(x)=10. If the same channel appears more than once in the list, the later appearance is selected for determining F. As such, if the channel x appears in e.g. the 10^{th} and the 21^{st} list entries, then F(x)=21.
A combination of two or more of MCW, MFW, and MRW values: The interest factor F(x) of a channel x is calculated based on two or more of the above methods. A weighting factor may selectively be applied to each of the MCW, MFW, and MRW values to selectively control the amount of influence of each value in F(x). Each weighting factor can be selected by the system designers, left to the viewer for selection, selected based on viewer usage (viewing) patterns, etc.

The present invention can be utilized even if full program guide information is unavailable, wherein a subset of program guide information, or a channel list, is displayed.

In another implementation, program guide display according to the present invention can be selectively utilized, or be a viewer-selectable option. For example, a TV or a STB implementing the present invention, may display the first five entries or the first page of the guide screen as described above, and then display the remainder of the guide screen based on other methods such as numerical order of the channel numbers, alphabetical order of the channel names, etc.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of presenting television program guide information, comprising the steps of:
obtaining a program guide;
monitoring program viewing patterns of a viewer; and
selectively presenting information from the program guide to the viewer based on the viewing patterns.

2. The method of claim 1 wherein selectively presenting information from the program guide further includes displaying a listing of channels viewed more frequently on a guide screen in descending order of viewing frequency.

3. The method of claim 2 wherein monitoring program viewing patterns further includes monitoring viewing pattern changes.

4. The method of claim 3 wherein selectively presenting information from the program guide further includes selectively presenting information from the program guide to the viewer based on the viewing pattern changes.

5. The method of claim 2 wherein channels of more interest to the viewer appear first on the guide screen relative to other channels.

6. The method of claim 5 wherein selectively presenting information from the program guide further includes showing program guide information for viewer preferred channels regardless of watching time.

7. The method of claim 1 further comprising monitoring viewing patterns of multiple viewers, and selectively presenting information from the program guide based on the viewing patterns.

8. The method of claim 1 wherein monitoring program viewing patterns of a viewer further includes maintaining a list of channels viewed by the viewer.

9. The method of claim 8 further comprising:
receiving a viewer request for display of program guide information;
determining an interest factor, F, for each of multiple channels on the list; and
selectively presenting channel information from the program guide in the order of interest factor F for each channel.

10. The method of claim 8 further comprising:
receiving a viewer request for channel change;
recording the current time and the requested channel number in the list; and
tuning to the requested channel.

11. The method of claim 9 wherein said list includes viewing history for the last N channels that the viewer tuned to.

12. The method of claim 11 wherein the viewing history per channel further includes time of tuning and length of tuning.

13. The method of claim 12 wherein the list includes one or more entries per tuned channel corresponding to one or more tunings to the channel during the last N channel changes.

14. The method of claim 13 wherein determining the interest factor F for a channel x includes calculating the accumulated tuned time for the channel x as the interest factor F for the channel x.

15. The method of claim 10 wherein determining the interest factor F for a channel x includes calculating the number of appearances of the channel x in the list as the interest factor F for the channel x.

16. The method of claim 10 wherein determining the interest factor for a channel x includes calculating the interest factor F as a function time of entry of the channel x in the list, indicating a most recently watched indicator for the channel x.

17. The method of claim 10 wherein determining the interest factor F for a channel x includes determining F as a combination of two or more of:
a most consistently watched (MCW) value representing the accumulated tuned time for the channel x;
a most frequently watched (MFW) value representing the number of appearances of the channel x in the list; and
a most recently watched (MRW) value that is a function time of entry of the channel x in the list, indicating a most recently watched indicator for the channel x.

18. The method of claim 17 wherein determining the interest factor F for a channel x further includes determining F as a weighted combination of two or more of said MCW, MFW, and MRW values for the channel x.

19. The method of claim 8 further comprising the step of selectively presenting program guide information based on viewing patterns for a subset of channels in the list.

20. The method of claim 8 further comprising the step of selectively presenting program guide information based on viewer-selectable parameters.

21. The method of claim 8 further comprising the step of selectively presenting program guide information for a set of channels based on the viewing patterns, and presenting other channel guide information based on other criteria.

22. A system for presenting television program guide information, comprising:
a program information manager (PIM) that is configured to monitor program viewing patterns of a viewer; and
a user interface manager (UIM) that is configured to selectively present information from the program guide to the viewer based on the viewing patterns.

23. The system of claim 22 wherein the UIM is further configured to selectively present information from the program guide further includes displaying a listing of channels viewed more frequently on a guide screen in descending order of viewing frequency.

24. The system of claim 23 wherein the PIM is further configured to monitor viewing pattern changes.

25. The system of claim 24 wherein the UIM is further configured to selectively present information from the program guide to the viewer based on the viewing pattern changes.

26. The system of claim 23 wherein the UIM is configured to display channels of more interest to the viewer on a guide screen first, relative to other channels.

27. The system of claim 24 wherein the UIM is further configured to present program information for viewer preferred channels regardless of watching time.

28. The system of claim 22 wherein:
the PIM is further configured to monitor viewing patterns of multiple viewers; and
the UIM is further configured to selectively present information from the program guide based on the viewing patterns.

29. The system of claim 22 wherein the PIM is further configured to monitor program viewing patterns of a viewer and maintain a list of channels viewed by the viewer.

30. The system of claim 29 wherein the UIM is further configured to receive a viewer request for display of program guide information, determine an interest factor, F, for each of multiple channels on the list, and selectively present channel information from the program guide in the order of interest factor F for each channel.

31. The system of claim 29 wherein the UIM is further configured to receive a viewer request for channel change, record the current time and the requested channel number in the list, and tune to the requested channel.

32. The system of claim 30 wherein said list includes viewing history for the last N channels that the viewer tuned to.

33. The system of claim 32 wherein the viewing history per channel further includes time tuning and length of tuning.

34. The system of claim 33 wherein the list includes one or more entries per tuned channel corresponding to one or more tunings to the channel during the last N channel changes.

35. The system of claim 34 wherein the UIM is further configured to determine the interest factor F for a channel x by calculating the accumulated tuned time for the channel x as the interest factor F for the channel x.

36. The system of claim 31 wherein the UIM is further configured to determine the interest factor F for a channel x by calculating the number of appearances of the channel x in the list as the interest factor F for the channel x.

37. The system of claim 31 wherein the UIM is further configured to determine the interest factor for a channel x by calculating the interest factor F as a function time of entry of the channel x in the list, indicating a most recently watched indicator for the channel x.

38. The system of claim 31 wherein the UIM is further configured to determine the interest factor F for a channel x by determining F as a combination of two or more of:
a MCW value representing the accumulated tuned time for the channel x;
a MFW value representing the number of appearances of the channel x in the list; and
a MRW value that is a function time of entry of the channel x in the list, indicating a most recently watched indicator for the channel x.

39. The system of claim 38 wherein the UIM is further configured to determine the interest factor F for a channel x by determining F as a weighted combination of two or more of said MCW, MFW, and MRW values for the channel x.

40. The system of claim 29 wherein the UIM is further configured to selectively present program guide information based on viewing patterns for a subset of channels in the list.

41. The system of claim 29 wherein the UIM is further configured to selectively present program guide information based on viewer-selectable parameters.

42. The system of claim 29 further wherein the UIM is further configured to selectively present program guide information for a set of channels based on the viewing patterns, and to present other channel guide information based on other criteria.
